(19) United States
(12) Patent Application Publication
(10) Pub. No.: US 2025/0360346 A1
(43) Pub. Date: Nov. 27, 2025

(54) FLAME ARRESTOR DEVICE AND METHOD FOR FLAME ARRESTMENT

(71) Applicant: BNR-CAPITAL B.V., Alkmaar (NL)

(72) Inventors: Tienus LUKKES, Alkmaar (NL); Elger Gjalt TURKSMA, Alkmaar (NL)

(21) Appl. No.: 19/136,793

(22) PCT Filed: Dec. 7, 2023
(86) PCT No.: PCT/NL2023/050643

§ 371 Date: Jun. 6, 2025

(30) Foreign Application Priority Data
Dec. 7, 2022 (NL) 2033687

(51) Int. Cl. A62C 4/02; F23K 5/00

(52) U.S. Cl. CPC A62C 4/02; F23K 5/007

(57) ABSTRACT

The invention relates to a flame arrestor device comprising a housing with a gas inlet, a gas outlet and a pressure chamber, wherein the gas inlet, the gas outlet and the pressure chamber define a gas flow channel through the housing, and further comprises a gas regulator that is positioned between the gas inlet and the pressure chamber and that is configured to selectively close off the gas flow channel and a flame retaining unit that is positioned between the gas regulator and the gas outlet. The invention further relates to the use of the device according to the invention to extinguish a flame in a gas feed line and to a method for extinguishing a flame in a gas feed line, preferably a hydrogen gas feed line.

The invention relates to a flame arrestor device, for example for a gas-fueled heating device, and a method for flame arrestment in heating devices, preferably in gas-fueled heating devices.

Gas-based devices, such as heating devices, electrolyzers and (gas) burners are known from practice. An example of such devices are heating devices for heating residential buildings, such as gas-fueled boilers and heaters operating on natural gas or biogas. Another example of such devices, which more recently have been developed are hydrogen-powered devices in which hydrogen is used as gaseous fuel.

In order to safely operate such abovementioned devices, a flame arrestor unit or device is provided, which is positioned near or (partially) in the gas inlet of the device. Flame arrestor devices are configured to stop the backflash or propagation of a flame into a fuel line or tank, such as a fuel supply line or tank, by reducing the fuel below ignition temperature.

The known flame arrestor devices often comprise a flame retaining chamber that is delineated by a flame retainer wall comprising a plurality of passages that during normal use allow a gas flow to penetrate the retainer wall. In case of a backflash, the flame retainer wall, partially due to the passages, absorbs the flame heat, which drops the temperature below ignition temperature, which douses the flame.

A disadvantage of the known flame arrestors is that a relatively high pressure is required to operate the flame arrestor. This renders the known flame arrestors less useful for devices operating at a low pressure, such as residential heating devices or low-pressure electrolyzers. This is especially true for devices that at least partially operate on locally or internally produced (non-pressurized) hydrogen.

The present invention is aimed at obviating or at least reducing the aforementioned problems by providing a flame arrestor device that is useable in devices that operate using low-pressure gaseous fuel.

To that end, the invention provides a flame arrestor device, the flame arrestor device comprising:
a housing comprising:
   a gas inlet;
   a gas outlet;
   a pressure chamber;
wherein the gas inlet, the gas outlet and the pressure chamber define a gas flow channel through the housing;
a gas regulator that is positioned between the gas inlet and the pressure chamber and that is configured to selectively close off the gas flow channel; and
a flame retaining unit that is positioned between the gas regulator and the gas outlet.

An advantage of the flame retaining device according to the invention is that, due to the combination of the gas regulator and the flame retaining unit, the device can be used for devices operating at (or producing) low pressure gaseous fuels.

Another advantage of the flame retaining device according to the invention is that the gas regulator also is configured to regulate the gas pressure in the device. This obviates the need for a separate gas regulating unit in the device.

A further advantage is that, in case of a backflash, the pressure in the pressure chamber will rise and the gas regulator, in combination with the biasing element, will close off the gas channel, therewith providing an additional safety measure against backflash.

It is noted that the flame arrestor device according to the invention can be employed in a wide range of devices, including in (gas-fueled) heating devices, gas burners and electrolyzers. In addition, the flame arrestor device according to the invention can be used in devices and/or installations of various sizes, including (large) industrial scale devices and installations and residential devices and installations.

It is noted that the words ‘flashback’ and ‘backflash’ both relate to the recession of a flame to an unwanted position to burn at a point where this was not intended. The wording is, in this application, considered exchangeable and both relate to the abovementioned flame recession.

In an embodiment of the flame arrestor device according to the invention, the pressure chamber is configured to contain a gas under pressure and/or is configured to withstand a rapid change in gas pressure.

An advantage of the pressure chamber is that it is capable of containing pressurized gas and/or is capable of withstanding a (rapid) pressure change due to a flashback occurring in the flame arrestor device.

In an embodiment of the flame arrestor device according to the invention, the regulator may comprises a regulator valve and a biasing means that is biased to maintain the regulator valve in a closed position, and wherein the biasing means preferably may comprise a spring or a hydraulic biasing means.

An advantage of this embodiment is that the combination of a regulator valve and a biasing means to bias the regulator valve is that it functions as flame arrestor as well as flow regulator for the gaseous fuel flow.

Another advantage is that the regulator valve remains closed if the fuel supply pressure falls below a predetermined value. This prevents other gases from entering the fuel supply line. Similarly, the regulator valve closes if the fuel supply pressure is lower than a pressure in the pressure chamber, in which case the biasing means and the pressure in the pressure chamber cooperate to close the regulator valve.

An advantage of a spring as biasing means is that it provides a robust and reliable biasing means.

Another advantage of a spring is that it is substantially insensitive to damage by the gaseous fuels, and especially by detoriation through hydrogen as fuel, which further increases its reliability.

In an embodiment of the flame arrestor device according to the invention, the biasing means may have a first end that is connected to the gas regulator valve and may have a second end, that is positioned opposite the first end, that is connected to the flame retaining unit.

An advantage of this embodiment is that it provides a compact and reliable construction. It is preferred in this embodiment that the flame retaining unit is positioned in a fixed location in the pressure chamber and therewith functions as an anchoring or base point for the biasing means.

Another advantage of this embodiment is that a direct connection is made between the flame retaining unit and the gas regulator valve.

In an embodiment of the flame arrestor device according to the invention, the gas regulator may comprise:
a control valve, preferably a magnetic control valve;
at least one inlet sensor that is positioned in the gas inlet and that is configured to provide sensor data, preferably pressure data; and
at least one downstream sensor that is positioned in the pressure chamber and/or in the gas outlet and that is configured to provide sensor data; and
a control unit configured to control the control valve at least partially based on sensor data from the sensors.

The gas regulator may, instead of providing mechanical control means, also provide electric or electronic control means. In this embodiment, the control is provided based on sensor data from the sensors. The control unit is configured to compare pressure data from the at least one inlet sensor with a pressure threshold value and actuate (and thus open) the control valve if the pressure in the gas inlet exceeds the pressure threshold value.

In case a flashback occurs, this will be measured and/or detected by the at least one downstream sensor, which provides the sensor data to the control unit. The control unit is configured to close the control valve in response to sensor data by the at least one downstream sensor even if the predetermined pressure in the gas inlet exceeds the pressure threshold value. In other words, control unit overrides the control rule or command that the control valve should be opened if the predetermined pressure in gas inlet exceeds the pressure threshold value. Optionally, the sensor data of the at least one downstream sensor may be compared to a threshold value, in which case the ‘close’ command is provided if the value in the (at least one) sensor data exceeds the threshold value.

An advantage of the abovementioned embodiment is that it provides a sophisticated control mechanism for controlling flashbacks.

In an embodiment of the flame arrestor device according to the invention, the downstream sensor may be a pressure sensor, a temperature sensor and/or combinations thereof.

It is preferred that the downstream sensor in the gas outlet is a temperature sensor that is capable of measuring (rapid) changes in temperature, which indicate a flashback flame. In case a downstream sensor is provided in the pressure chamber, the sensor preferably is a pressure sensor to detect a (rapid) pressure changes in the pressure chamber as an indication of a flashback. Naturally, combinations of sensors or multiple different sensors may also be used.

In an embodiment of the flame arrestor device according to the invention, the gas regulator may, instead of comprising a valve, also comprises a cylindrical closure that is moveable with respect to the gas inlet to selectively open and/or close off the gas inlet, wherein the cylindrical closure preferably is electrically, magnetically or hydraulically operated.

In an embodiment of the flame arrestor device according to the invention, the regulator may have an open position in which the gas inlet and the pressure chamber are fluidly connected to allow a gas flow through the flame arrestor device, and may have a closed position in which the regulator closes off the gas channel between the gas inlet and the pressure chamber.

If the gas regulator is moveable between an open and a closed position, it allows the gas regulator to regulate the amount of gas allowed into the pressure chamber to be provided for example by the inlet pressure of the gas at the gas inlet. In addition, the gas regulator closes off the pressure chamber if the gas inlet pressure is too low, that is below a predetermined pressure, or when the pressure in the pressure chamber becomes higher than the gas inlet pressure, for example due to a backflash in the gas line leading to the gas burner of a gas heating device to which (or in which) the flame arrestor device is connected.

In an embodiment of the flame arrestor device according to the invention, the device may further comprise a sealing ring that is positioned between the gas inlet and the pressure chamber and that is configured to cooperate with the regulator to selectively close off the gas channel.

An advantage of the sealing ring is that it provides additional sealing between the gas inlet and the pressure chamber when the gas regulator closes off (that is, when it is in the closed position) the gas channel. The sealing is, to that end, preferably positioned at or near an edge of the gas inlet and/or adjacent to the pressure chamber to, in cooperation with the gas regulator, provide an improved sealing.

In an embodiment of the flame arrestor device according to the invention, the biasing means of the gas regulator may be biased to a predetermined opening pressure, and the predetermined opening pressure may be in the range of 5-50 mbar, may preferably be in the range of 10-40 mbar and most preferably may be in the range of 20 mbar-25 mbar.

It has been found that a pressure in the abovementioned range provides an excellent fuel supply and flame extinguishing properties. These particular ranges provide sufficient pressure to supply a low pressure heating device, while simultaneously maintaining regulating and flame arresting properties.

In an embodiment of the flame arrestor device according to the invention, the flame retaining unit may comprise:
a flow guide that is positioned in the pressure chamber between the gas regulator and the gas outlet, wherein the flow guide divides the pressure chamber in a first pressure chamber part and a second pressure chamber part;
a flame retainer wall that extends between the flow guide and the gas outlet and that encloses a flame retainer chamber;
a peripheral space that that extends between the flame retainer wall and an inner side of the second pressure chamber part;
wherein the flow guide has one or more flow openings that fluidly connect the first pressure chamber part with the peripheral space of the second pressure chamber part, and wherein the flame retainer wall has a plurality of flow passages.

An advantage of the present embodiment is that a compact and efficient flame retainer is provided, which is primarily useable to extinguish a backflash flame, such that the backflash substantially only results in an increase in pressure in the peripheral part of the second pressure chamber and in the part first pressure chamber part.

In an embodiment of the flame arrestor device according to the invention, the flame retainer wall is a cylindrical wall that extends parallel to a longitudinal arrestor axis.

An advantage of this embodiment is that the flame arrestor wall forms a cylindrical chamber that provides a separation between the flame retainer wall and the peripheral part of the second pressure chamber part.

In an embodiment of the flame arrestor device according to the invention, the flame retainer wall may be manufactured of a sintered porous material.

It has been found that the use of a sintered porous material provides excellent arresting properties, while simultaneously allowing a gas flow through the wall towards the gas outlet during normal operation.

In an embodiment of the flame arrestor device according to the invention, the flow passages in the flame retainer wall have a high gas throughput.

By providing a high gas throughput, the flame arrestor device can be used with a wide range of devices, including devices that require a large supply of gaseous fuel (per time unit) or that produce a large quantity of gaseous fuel (per time unit). This for example concerns heating devices that are configured to provide a high output of heated water, such as heating devices that are capable of providing at least 7.5 litres of water per minute at a temperature of 60° C.

It is noted that the gas throughput as mentioned above refers to gaseous fuel/fuel in the gas-vapor phase.

In an embodiment of the flame arrestor device according to the invention, the flame arrestor device may be configured to operate at a gas temperature in the range of 0° C. to 100° C., preferably in the range from 0° C. to 75° C.

It has been found that the flame arrestor device according to the invention is capable of operating at a wide range of gas temperatures as provided above. As a result, the flame arrestor device according to the invention provides a flexible and versatile flame arrestor device.

In an embodiment of the flame arrestor device according to the invention, the flame arrestor device may be configured to operate at an ambient temperature in the range of 0° C. to 100° C., preferably from 0° C. to 75° C.

It has been found that the flame arrestor device according to the invention is capable of operating at a wide range of ambient temperatures as provided above. As a result, the flame arrestor device according to the invention provides a flexible and versatile flame arrestor device. In some cases, the flame arrestor device according to the invention may even be used at temperatures that are below 0° C.

In an embodiment of the flame arrestor device according to the invention, the flame arrestor device may be configured to operate at a pressure in the range of 2 mbar-1,000 mbar, preferably in the range of 8 mbar-850 mbar, more preferably in the range of 15 mbar-800 mbar and most preferably in the range of 20 mbar-750 mbar.

Due to the gas regulator, and the combination thereof with the flame arrestor unit, the device according to the invention is capable of operating at a wide range of pressures, including low pressure applications. Especially the operation at low pressure is not or hardly possible using the known flame arrestor devices.

In an embodiment of the flame arrestor device according to the invention, the device is a hydrogen flame arrestor device.

The device according to the invention can also be used in (low pressure) hydrogen fuel supplies, which increases its versatility.

In an embodiment of the flame arrestor device according to the invention, the gas regulator may at least partially be manufactured from Teflon or may be provided with a Teflon coating.

An advantage of Teflon is that it provides excellent protection against temperature differences and, when used as a coating, provides excellent protection against wear of the underlying material, which may for example be stainless steel.

The invention also relates to a method for extinguishing a flame in a gas feed line, preferably a hydrogen gas feed line, the method comprising:
providing a flame arrestor device according to the invention; and
operating the flame arrestor device.

The method according to the invention provides similar effects and advantages as the flame arrestor device according to the invention. It is noted that the method according to the invention may freely be combined with embodiments of the flame arrestor device according to the invention or parts of the embodiments thereof.

In an embodiment of the method according to the invention, the step of operating the flame arrestor device comprises the steps of:
arresting a backflash flame in the flame retainer unit, and
closing off the gas channel by closing the gas regulator.

In an embodiment of the method according to the invention, the step of operating the flame arrestor device comprises the step of regulating a gas flow through the flame arrestor device by selectively opening and closing the gas regulator.

An advantage of the method according to the invention is that the flame arrestor device is usable to arrest a (backflash) flame and to regulate a gas flow through the device.

The invention also relates to the use of a flame arrestor device according to the invention.

The use according to the invention provides similar effects and advantages as the flame arrestor device and the method according to the invention. It is noted that the use according to the invention may freely be combined with embodiments of the flame arrestor device and/or the method according to the invention or parts of the embodiments thereof.

Further advantages, features and details of the invention are elucidated on the basis of preferred embodiments thereof, wherein reference is made to the accompanying drawings, in which:

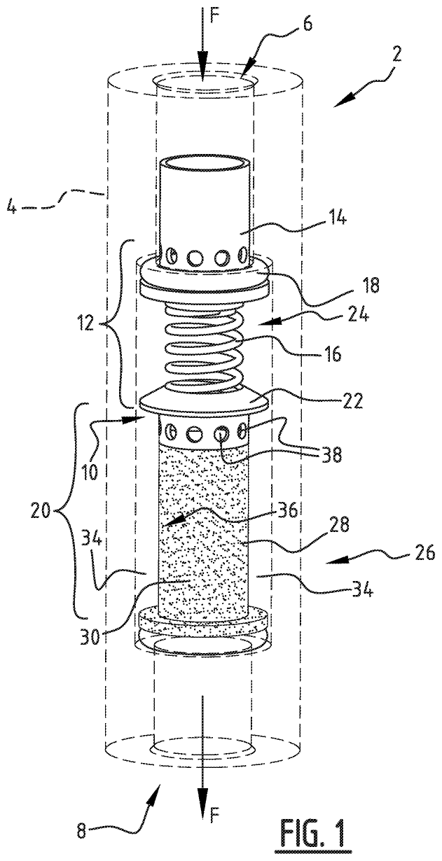

FIG. 1 shows a schematic cross-section of an example flame arrestor device according to the invention:

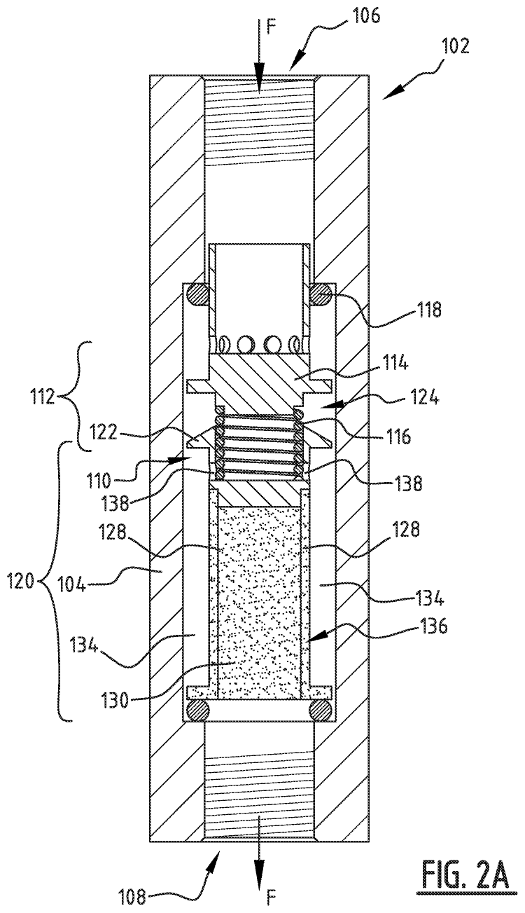

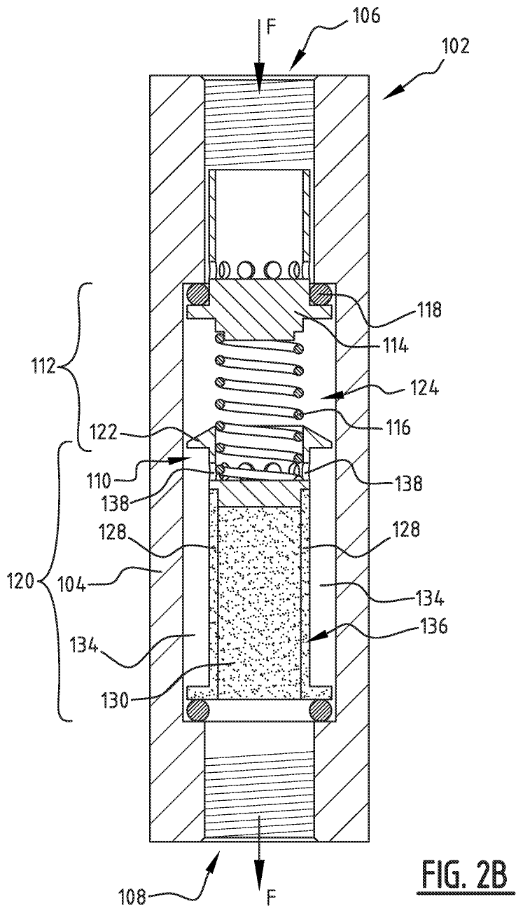

FIGS. 2A, 2B show schematic cross-sections of an example of a flame arrestor device according to the invention in respectively the open and the closed position;

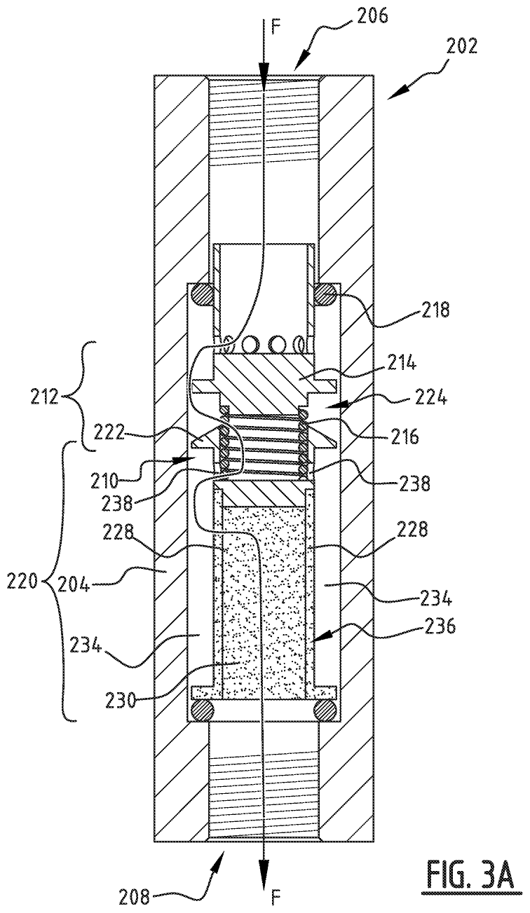

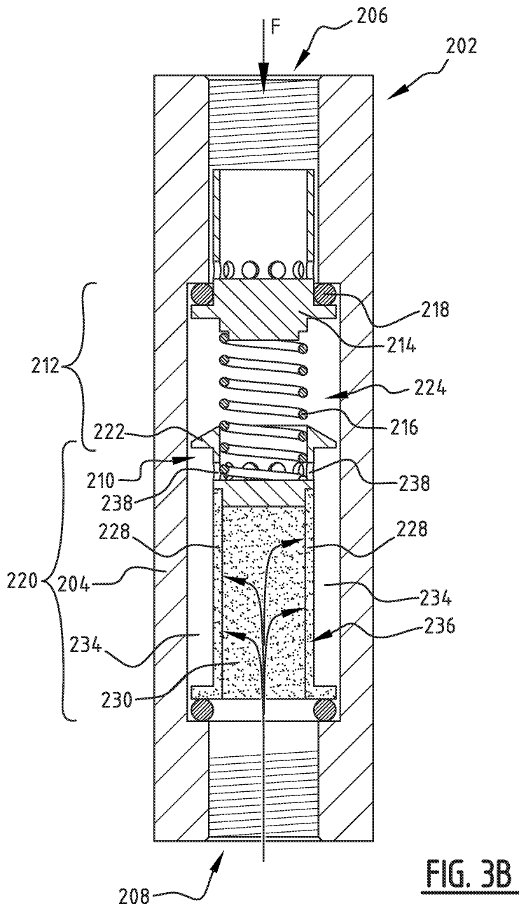

FIGS. 3A and 3B show schematic cross-sections of an example of a flame arrestor device according to the invention respectively during normal use and during a backflash;

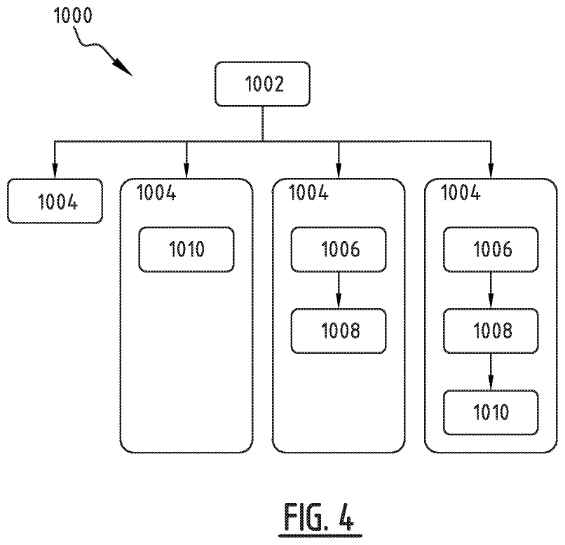

FIG. 4 shows a schematic overview of an example of the method according to the invention;

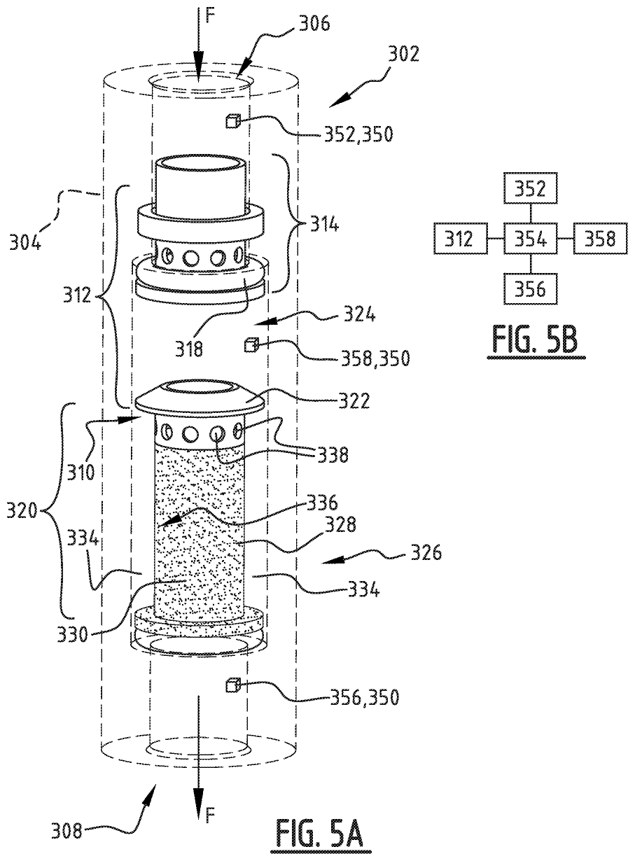

FIG. 5A shows a schematic cross-section of a second example flame arrestor device according to the invention; and

FIG. 5B shows a schematic view of an example of a gas regulator with the attached sensors.

In an example of the flame arrestor device 2 according to the invention, flame arrestor device 2 comprises housing 4 having gas inlet 6, gas outlet 8 and pressure chamber 10 which is positioned between gas inlet 6 and gas outlet 8. Gas inlet 6, gas outlet 8 and pressure chamber 10 together define flow channel F or flow path F. In this example, gas regulator 12 is provided at the junction of gas inlet 6 and pressure chamber 10. Gas regulator 12 in this example comprises gas regulator valve 14 or simply regulator valve 14 and biasing means 16. In this particular example, biasing means 16 is provided as biased spring 16, although any other suitable biasing means 16, such as a hydraulic biasing means having a piston, can be used as well.

Sealing 18, which in this example is sealing ring 18, is provided between gas regulator 12 and gas inlet 6 to provide an even better sealing between gas inlet 6 and gas regulator 12 when the latter is in a closed position (see FIG. 2B).

Flame arrestor device 2 in this example further comprises flame arrestor unit 20. Flame arrestor unit 20 includes flow guide 22 that is positioned in pressure chamber 10 between gas regulator 14 and gas outlet 8 and divides pressure chamber 10 in first pressure chamber part 24 and second pressure chamber part 26. First pressure chamber part 24 extends between gas regulator 14 and flow guide 22 and contains biased spring 16. Biased spring 16 has first end 16a that is connected to gas regulator 14 and second end 16b that is connected to flow guide 22. Second pressure chamber part 26 includes flame retainer wall 28 that extends between flow guide 22 and gas outlet 8 and is connected to both to enclose flame retainer chamber 30. As such, second pressure chamber part 26 is partitioned by flame retainer wall 28 in two parts that in this example are concentrically placed with each other. This means that between flame retainer wall 28 and inner side 32 of the second pressure chamber part 26 peripheral space 34 is positioned. To provide the flame retaining properties, flame retainer wall 28 is provided with a plurality of passages 36. Furthermore, flow guide 22 is provided with flow openings 38 that emanate in peripheral space 34.

In use (see FIG. 3A), gas regulator 14 of flame arrestor device 2 is moveable between a closed position (see FIG. 2B) and an open position (see FIG. 2A) to regulate a flow of gaseous fuel through flame arrestor device 2.

In use, fuel is provided to gas inlet 6 at a predetermined pressure. If the predetermined pressure exceeds the biasing force of biased spring 16, gas regulator 14 moves from a closed position to an open position and fuel moves through flow channel F towards gas outlet 8. Thereto, it flows under pressure through first pressure chamber part 24 through flow openings 38 of flow guide 22 into peripheral space 34. From peripheral space 34 it flows through flow passages 36 in flame retainer wall 28 into flame retainer space 30 and subsequently through gas outlet 8.

In case of a backflash (see FIG. 3B), a backflash flame or flow is forced through gas outlet 8 into flame retainer space 30. As such, the flow than moves in the opposite direction of the flow during normal operation. In flame retainer space 30, it is forced into, and partially through, flow passages 36 of flame retainer wall 28. Due to the entry in flow passages 36, the gas temperature is reduced below the ignition temperature and the backflash flame is extinguished.

The gas that is partially forced through flow passages 36 into peripheral space 34 flows through flow guide 22 into first pressure chamber part 24, in which it increases the pressure. As a result, the combined pressure and biasing force of biased spring 16 exceeds the pressure of the feed flow through gas inlet 6 and force gas regulator 14 in a closed position.

In a second example of flame arrestor device 302 according to the invention (see FIG. 5A, 5B), flame arrestor device 302 comprises housing 304 having gas inlet 306, gas outlet 308 and pressure chamber 310 which is positioned between gas inlet 306 and gas outlet 308. Gas inlet 306, gas outlet 308 and pressure chamber 310 together define flow channel F or flow path F. In this example, gas regulator 312 is provided at the junction of gas inlet 306 and pressure chamber 310. Gas regulator 312 in this example comprises magnetic control valve 314 that is biased to a closed position. When actuated, magnetic control valve 314 is partially or completely opened to allow a gas flow from gas inlet 306 into pressure chamber 310. The actuation of magnetic control valve 314 is, in this example, provided by pressure data received from pressure sensor 352 and controlled by control unit 354. Control unit 354 is configured to actuate control valve 314 if the pressure in gas inlet 306 measured by pressure sensor 352 exceeds a pressure threshold value. In this example, control unit 354 is a part of gas regulator 312, although it also may be a separate control unit.

Sealing 318, which in this example is sealing ring 318, is provided between gas regulator 312 and gas inlet 306 to provide an even better sealing between gas inlet 306 and gas regulator 312 when the latter is in a closed position.

Flame arrestor device 302 in this example further comprises flame arrestor unit 320. Flame arrestor unit 320 includes flow guide 322 that is positioned in pressure chamber 310 between gas regulator 314 and gas outlet 308 and divides pressure chamber 310 in first pressure chamber part 324 and second pressure chamber part 326. First pressure chamber part 324 extends between gas regulator 314 and flow guide 322. Second pressure chamber part 326 includes flame retainer wall 328 that extends between flow guide 322 and gas outlet 308 and is connected to both to enclose flame retainer chamber 330. As such, second pressure chamber part 326 is partitioned by flame retainer wall 328 in two parts that in this example are concentrically placed with each other. This means that between flame retainer wall 328 and inner side 332 of the second pressure chamber part 326 peripheral space 334 is positioned. To provide the flame retaining properties, flame retainer wall 328 is provided with a plurality of passages 336. Furthermore, flow guide 322 is provided with flow openings 338 that emanate in peripheral space 334.

Flame arrestor device 302 further comprises at least one sensor 350 that is operatively connected to gas regulator 312. In this example, at least one sensor 350 comprises temperature sensor 356 that is positioned in gas outlet 308 and pressure sensor 358 that is positioned in first pressure chamber part 324.

In use, gas regulator 314 of flame arrestor device 302 is moveable between a closed position and an open position to regulate a flow of gaseous fuel through flame arrestor device 302. To that end, fuel is provided to gas inlet 306 at a predetermined pressure that exceeds the pressure threshold value. The predetermined pressure measured by pressure sensor 352 thus exceeds the pressure threshold value, which causes control unit 354 to actuate control valve 314 and move it from a closed to an at least partially (and preferably completely) open position. As a result, fuel moves through flow channel F towards gas outlet 308. Thereto, it flows under pressure through first pressure chamber part 324 through flow openings 338 of flow guide 322 into peripheral space 334. From peripheral space 334 it flows through flow passages 336 in flame retainer wall 328 into flame retainer space 330 and subsequently through gas outlet 308.

In case of a backflash, a backflash flame or flow is forced through gas outlet 308 into flame retainer space 330. As such, the flow than moves in the opposite direction of the flow during normal operation. In flame retainer space 330, it is forced into, and partially through, flow passages 336 of flame retainer wall 328. Due to the entry in flow passages 336, the gas temperature is reduced below the ignition temperature and the backflash flame is extinguished.

The (sudden) increase in temperature in gas outlet 308 is measured by temperature sensor 356 and provided to control unit 354. In response, control unit 354 is configured to close magnetic control valve 314, even if the predetermined pressure in gas inlet 306 exceeds the pressure threshold value. In other words, control unit 354 overrides the control rule that magnetic control valve 314 should be opened if the predetermined pressure in gas inlet 306 exceeds the pressure threshold value.

Simultaneously, gas is partially forced through flow passages 336 into peripheral space 334 flows through flow guide 322 into first pressure chamber part 324, in which it increases the pressure. The pressure increase is measured by pressure sensor 358, which provides the pressure data to control unit 354. In response, control unit 354 is configured to close magnetic control valve 314 if that had not been done in response to the signal by temperature sensor 356. The closure command is provided by control unit 354 even if the predetermined pressure in gas inlet 306 exceeds the pressure threshold value. In other words, control unit 354 overrides the control rule that magnetic control valve 314 should be opened if the predetermined pressure in gas inlet 306 exceeds the pressure threshold value.

In an example of method 1000 according to the invention (see FIG. 4), method 1000 comprises the steps of providing 1002 a flame arrestor device according to the invention, and operating 1004 the flame arrestor device.

The step of operating the flame arrestor device may comprise the steps of arresting 1006 a backflash flame in the flame retainer unit, and closing off 1008 the gas channel by closing the gas regulator. Additionally or alternatively, the step of operating the flame arrestor device in method 1000 of this example may comprise the step of regulating 1010 a gas flow through the flame arrestor device by selectively opening and the step of operating the flame arrestor device closing the gas regulator.

The present invention is by no means limited to the above described preferred embodiments and/or experiments thereof. The rights sought are defined by the following claims within the scope of which many modifications can be envisaged.

1. Flame arrestor device comprising:
a housing comprising:
a gas inlet;
a gas outlet;
a pressure chamber;
wherein the gas inlet, the gas outlet and the pressure chamber define a gas flow channel through the housing;
a gas regulator that is positioned between the gas inlet and the pressure chamber and that is configured to selectively close off the gas flow channel; and
a flame retaining unit that is positioned between the gas regulator and the gas outlet.

2. Flame arrestor device according to claim 1, wherein the regulator comprises a regulator valve and a biasing means that is biased to maintain the regulator valve in a closed position, and wherein the biasing means preferably comprise a spring or a hydraulic biasing means.

3. Flame arrestor device according to claim 2, wherein the biasing means has a first end that is connected to the gas regulator valve and a second end, that is positioned opposite the first end, that is connected to the flame retaining unit.

4. Flame arrestor device according to claim 1, wherein the regulator has an open position in which the gas inlet and the pressure chamber are fluidly connected to allow a gas flow through the flame arrestor device, and a closed position in which the regulator closes off the gas channel between the gas inlet and the pressure chamber.

5. Flame arrestor device according to claim 1, further comprising a sealing ring that is positioned between the gas inlet and the pressure chamber and that is configured to cooperate with the regulator to selectively close off the gas channel.

6. Flame arrestor device according claim 2, wherein the biasing means of the gas regulator is biased to a predetermined opening pressure, and wherein the predetermined opening pressure is in the range of 5-50 mbar, preferably in the range of 10-40 mbar and most preferably about 20 mbar.

7. Flame arrestor device according to claim 1, wherein the flame retaining unit comprises:
a flow guide that is positioned in the pressure chamber between the gas regulator and the gas outlet, wherein the flow guide divides the pressure chamber in a first pressure chamber part and a second pressure chamber part;
a flame retainer wall that extends between the flow guide and the gas outlet and that encloses a flame retainer chamber;
a peripheral space that extends between the flame retainer wall and an inner side of the second pressure chamber part;
wherein the flow guide has one or more flow openings that fluidly connect the first pressure chamber part with the peripheral space of the second pressure chamber part, and wherein the flame retainer wall has a plurality of flow passages.

8. Flame arrestor device according to claim 1, wherein the flame retainer wall is manufactured of a sintered porous material.

9. Flame arrestor device according to claim 1, wherein the flame arrestor device is configured to operate at a gas temperature range of 0° C. to 100° C., preferably from 0° C. to 75° C.

10. Flame arrestor device according to claim 1, wherein the flame arrestor device is configured to operate at a pressure in the range of 2 mbar-1,000 mbar, preferably in the range of 8 mbar-850 mbar, more preferably in the range of 15 mbar-800 mbar and most preferably in the range of 20 mbar-750 mbar.

11. Flame arrestor device according to claim 1, wherein the device is a hydrogen flame arrestor device.

12. Flame arrestor device according to claim 1, wherein the gas regulator is at least partially manufactured from Teflon® or is provided with a Teflon® coating.

13. Method for extinguishing a flame in a gas feed line, preferably a hydrogen gas feed line, the method comprising:
providing a flame arrestor device according to claim 1;
operating the flame arrestor device.

14. Method according to claim 13, wherein the step of operating the flame arrestor device comprises the steps of:
arresting a backflash flame in the flame retainer unit, and
closing off the gas channel by closing the gas regulator.

15. Method according to claim 13, wherein the step of operating the flame arrestor device comprises the step of regulating a gas flow through the flame arrestor device by selectively opening and closing the gas regulator.

16. Use of a flame arrestor device according to claim 1 to arrest a flame.
